(19) United States
(12) Patent Application Publication
(10) Pub. No.: US 2007/0091049 A1
(43) Pub. Date: Apr. 26, 2007

(54) Electron emission display device and control method thereof

(76) Inventor: Duck Gu Cho, Changnyeong-gun (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/580,435

(22) Filed: Oct. 13, 2006

(30) Foreign Application Priority Data
Oct. 21, 2005 (KR) 10-2005-0099912

(51) Int. Cl. G09G 3/36

(52) U.S. Cl. 345/98

(57) ABSTRACT

An electron emission display device and a control method thereof, which previously store variable voltage information according to a drive time and/or a size of frame data, and maintain current amount constant without measuring an electric current at the driving time of a real screen in order to prevent a degradation of a pixel are disclosed. A pixel portion includes a plurality of scan lines and a plurality of data lines, and an anode electrode is over an entire region of the pixel portion. A data driver transfers a data signal to the data lines. A scan driver sequentially transfers a scan signal to the scan lines. A power supply unit supplies a electric drive source to the data driver and the scan driver. A controller stores variable voltage information corresponding to a drive time and for maintaining an electric current flowing through the anode electrode constant based on the stored variable voltage information.

### CROSS-REFERENCE TO RELATED APPLICATIONS

This application claims the benefit of Korean Patent Application No. 10-2005-0099912, filed on Oct. 21, 2005, in the Korean Intellectual Property Office, the disclosure of which is incorporated herein by reference.

### BACKGROUND OF THE INVENTION

1. Field of the Invention

The present invention relates to an electron emission display device and a control method thereof. More particularly, the present invention relates to an electron emission display device and a driving method thereof, which provides current compensation based on pre-stored information without measuring an electric current.

2. Description of the Related Technology

Recently, flat panel displays such as a liquid crystal display (LCD), plasma display panel (PDP), electro luminescent display (ELD), or electron emission display (EED) have been developed. Among the flat panel displays, an electron emission display device includes an electron emission device. The electron emission device has an electron emission region and an image expression region. The electron emission region is a region for emitting electrons. In the image expression region, the electrons emitted from the electron emission region collide with a fluorescent layer to emit light. More particularly, an electron emission display device has excellent image characteristics such as high image quality, high resolution, and wide viewing angle. In addition, an electron emission display device has a lightweight and thin panel structure, and low power consumption.

In general, there are electron emission devices of a heat emission type and a cold cathode type, which use a heat cathode and a cold cathode, respectively, as an electron source. In electron emission devices of a heat emission type, a high voltage is applied to a material such as tungsten to heat to a high temperature to emit electrons. Recently, electron emission devices of a cold type that do not need to be heated to a high temperature and can emit electrons even at a low voltage have been actively developed.

Various kinds of electron emission devices of the cold cathode type are available. Examples of cold cathode type electron emission devices include a field emitter array (FEA) type, a surface conduction emitter (SCE) type, a metal-insulator-metal (MIM) type, a metal-insulator-semiconductor (MIS) type, and a ballistic electron surface emitter (BES) type.

An FEA type electron emission device emits electrons due to an electric field difference under a vacuum atmosphere by using materials, a work function of which is low or β function is high as an electron emitting source. An FEA type electron emission device using a tip structure having a shape-pointed front end, carbon system materials, or nano materials as an electron emitting source has been developed.

In an SCE type electron emission device, a conductive thin film is formed on a substrate between two electrodes facing each other. An electron emitting portion is formed by making fine cracks in the conductive thin film. The SCE type electron emission device applies a voltage to an electrode to flow an electric current through a surface of the conductive thin film. Electrons are emitted from an electron emitting portion having a fine gap.

In an MIM type electron emission device, an electron emitting portions with an MIN structure is formed. When a voltage is applied to two metals having an insulator therebetween, electrons are moved and accelerated from a metal having a higher electron potential to a metal having a lower electron potential.

In an MIS type electron emission device, an electron emitting portion with an MIS structure is formed. When a voltage is applied to a metal and a semiconductor having an insulator therebetween, electrons are moved and accelerated from a semiconductor having a higher electron potential to a metal having a lower electron potential to be emitted.

In a BSE type electron emission device, an electron supply layer having a metal or a semiconductor is formed on an ohmic electrode based on the following principle. The principle is that electrons travel without dispersion when a size of a semiconductor is reduced to a size range less than a mean free path of an electron in the semiconductor. An insulation layer and a metal thin film are formed on the electron supply layer. By applying a power source to the ohmic electrode and the metal thin film, electrons are emitted.

In the above-mentioned electron emission device, as emitted electrons collide with a fluorescent layer, the fluorescent layer emits light. Accordingly, a luminance of a displayed image varies according to an inputted video data value. In detail, the video data value includes RGB data of 8 bits. The video data value may have one of 0(00000(binary)) to 255(11111111(binary)), and a luminance of each pixel is expressed by the video data value.

In order to adjust the luminance expressed by the video data value, a pulse width modulation (PWM) method or a pulse amplitude modulation (PAM) method is generally used.

The PWM method modulates a pulse width of a drive waveform applied to a data electrode according to video data inputted to a data driver. When 255 is inputted in a available maximum on-time as the video data value, the pulse width becomes a maximum value to display a maximum luminance. When 127 is inputted as the video data value, the pulse width becomes ½, thereby lowering the luminance. In contrast to this, in the PAM method, the pulse width is constant regardless of inputted video data. However, by changing a pulse voltage level, i.e., a pulse amplitude of the drive waveform applied to a data electrode according to inputted video data, the luminance is adjusted.

In the above mentioned electron emission display device, when video data of a value of R:11111111(binary), G:11111111(binary), B:11111111(binary), i.e., 255s are inputted to a data driver, a pulse width or a pulse amplitude is modulated according to video data regardless of a luminance level of a total of the input video data, so that the luminance is determined.

FIG. 1 is view showing a configuration of an electron emission display device. With reference to FIG. 1, the electron emission display device includes a pixel portion 10, a data driver 30, a scan driver 20, and a power supply unit 40.

The pixel portion 10 includes n scan lines S1, S2, . . . , Sn, m data lines D1, D2, . . . , Dm, and an anode electrode. A plurality of pixels 5 are formed at regions defined by the n scan lines S1, S2, . . . , Sn and the data lines D1, D2, . . . , Dm. The anode electrode may be formed over the entire area of the pixel portion 10. One of the scan lines S1, S2, . . . , Sn and the data lines D1, D2, . . . , Dm acts as a cathode electrode, the other acts as a gate electrode.

The data driver 30 applies a data signal corresponding to input video data to a plurality of data lines D1, D2, . . . , Dm, respectively. The scan driver 20 sequentially applies a scan signal to a plurality of scan lines S1, S2, . . . , Sn.

The power supply unit 40 applies a first power source V1 and a second power source V2 to the scan driver 20. Further, the power supply unit 40 applies a third power source V3 and a fourth power source V4 to the data driver 30.

In the electron emission display device having the above construction, as the operation time elapses, a pixel 5 is degraded and thereby increases an internal resistance. This causes the luminance of the pixel 5 to be gradually lowered.

### SUMMARY OF CERTAIN INVENTIVE ASPECTS

One aspect of the invention provides an electron emission display device. The device comprises: an array of pixels comprising a first pixel configured to flow an emission current therein and emit light when a pixel voltage is applied thereto; and a luminance adjusting circuit configured to adjust the pixel voltage based on the extent of use of the device since an initiation of the circuit.

The luminance adjusting circuit may be configured to increase the pixel voltage, thereby increasing the emission current. The luminance adjusting circuit may be configured to increase the pixel voltage by a predetermined value corresponding to the extent of use of the device. The extent of use of the device may comprise an accumulated time in which the first pixel is turned on. The luminance adjusting circuit may be configured to increase the pixel voltage by a predetermined value when the accumulated time reaches a predetermined value. The extent of use of the device may comprise an accumulated time in which the device is turned on. The luminance adjusting circuit may comprise a timer for measuring the accumulated time.

The array may be configured to receive data indicative of luminance levels of the pixels when displaying an image, and the extent of use of the device may comprise the sum of the luminance levels for at least part of the pixels in the array since the initiation of the circuit. The luminance adjusting circuit may be further configured to sum the luminance levels. The luminance adjusting circuit may be configured to increase the pixel voltage by a predetermined value when the sum of luminance levels reaches a predetermined value.

The extent of use of the device may further comprise an accumulated time in which the device is turned on since the initiation of the circuit. The luminance adjusting circuit may be configured to determine whether the accumulated time reaches a predetermined value when the sum of luminance levels reaches a predetermined value. The luminance adjusting circuit may be configured to determine whether the sum of luminance levels reaches a predetermined value when the accumulated time reaches a predetermined value.

The array may be configured to receive data indicative of luminance levels of the pixels when displaying an image, and the extent of use of the device may comprise an accumulated value of the data received for at least part of the pixels in the array since the initiation of the circuit. The luminance adjusting circuit may be further configured to sum values of the data.

Another aspect of the invention provides a method of adjusting luminance of an electron emission display device. The method comprises: providing the device described above; determining that the extent of use of the device since the initiation of use of the device has reached a predetermined value; and adjusting the luminance of the first pixel upon determination.

Adjusting the luminance may comprise increasing the pixel voltage, thereby increasing the emission current. Determining may comprise: quantifying the extent of use to a value; and comparing the quantified value against the predetermined value. The luminance adjusting circuit may determine that the extent of use has reached the predetermined value when the quantified value is the same or greater than the predetermined amount at the time of determination. The device may comprise a memory storing a lookup table with a plurality of extent of use values and a plurality of pixel voltage values corresponding to the plurality of extent of use values.

Another aspect of the invention provides an electron emission display device and a control method thereof, which previously store variable voltage information according to a drive time and/or a size of frame data, and maintain current amount constant without measuring an electric current at the driving time of a real screen in order to prevent a degradation of a pixel.

Another aspect of the invention provides an electron emission display device comprising: a pixel portion including a plurality of scan lines and a plurality of data lines, and an anode electrode over an entire region of the pixel portion; a data driver for transferring a data signal to the data lines; a scan driver for sequentially transferring a scan signal to the scan lines; a power supply unit for supplying a electric drive source to the data driver and the scan driver; and a controller for storing variable voltage information corresponding to a drive time and for maintaining an electric current flowing through the anode electrode constant based on the stored variable voltage information.

Another aspect of the invention provides an electron emission display device comprising: a pixel portion including a plurality of scan lines and a plurality of data lines, and an anode electrode over an entire region of the pixel portion; a data driver for transferring a data signal to the data lines; a scan driver for sequentially transferring a scan signal to the scan lines; a power supply unit for supplying a electric drive source to the data driver and the scan driver; and a controller for changing a voltage according to a size of a total of video data inputted during one frame time period in order to maintain an electric current flowing through the anode electrode.

Another aspect of the invention provides an electron emission display device comprising: a pixel portion including a plurality of scan lines and a plurality of data lines, and an anode electrode over an entire region of the pixel portion; a data driver for transferring a data signal to the data lines; a scan driver for sequentially transferring a scan signal to the scan lines;; a power supply unit for supplying a electric drive source to the data driver and the scan driver; and a controller for changing a voltage according to a drive time and a size of a total of video data inputted during one frame time period in order to maintain an electric current flowing through the anode electrode.

Another aspect of the invention provides a control method of an electron emission display device, comprising the steps of: (a) measuring a drive time and storing a variable voltage corresponding to the drive time in a look-up table; and (b) adjusting an electric current flowing through an anode electrode of a pixel portion constant according to the variable voltage stored in the look-up table.

Another aspect of the invention provides a control method of an electron emission display device, comprising the steps of: (a) summing video data inputted to a pixel portion during one frame time period to generate frame data, and storing a variable voltage corresponding to the frame data in a look-up table; and (b) adjusting an electric current flowing through an anode electrode of the pixel portion constant according to the variable voltage stored in the look-up table.

Another aspect of the invention provides a control method of an electron emission display device, comprising the steps of: (a) measuring a drive time; (b) summing video data inputted to a pixel portion during one frame time period to generate frame data, and storing a variable voltage corresponding to the drive time and the frame data in a look-up table; and (c) adjusting an electric current flowing through an anode electrode of a pixel portion constant according to the variable voltage stored in the look-up table.

### BRIEF DESCRIPTION OF THE DRAWINGS

These and/or other aspects and advantages of the invention will become apparent and more readily appreciated from the following description of embodiments, taken in conjunction with the accompanying drawings of which:

FIG. 1 is a schematic view showing an electron emission display device;

FIG. 2 is a schematic view showing an electron emission display device according to an embodiment;

FIG. 3 is a schematic view showing one embodiment of the controller of FIG. 2;

FIG. 4 is a schematic view showing another embodiment of the controller of FIG. 2;

FIG. 5 is a schematic view showing yet another embodiment of the controller of FIG. 2;

FIG. 6 is a flowchart illustrating a control method of an electron emission display device according to an embodiment;

FIG. 7 is a flowchart illustrating a control method of an electron emission display device according to another embodiment;

FIG. 8 is a flowchart illustrating a control method of an electron emission display device according to another embodiment; and

FIG. 9 is a schematic cross-sectional view showing an example of an electron emission device used for an electron emission display device according to one embodiment.

### DETAILED DESCRIPTION OF CERTAIN INVENTIVE EMBODIMENTS

Hereinafter, embodiments according to the invention will be described with reference to the accompanying drawings. Here, when one element is connected to another element, one element may be either directly connected to another element or indirectly connected to another element via another element. Further, irrelevant elements are omitted for clarity. Also, like reference numerals indicate identical or functionally similar elements throughout.

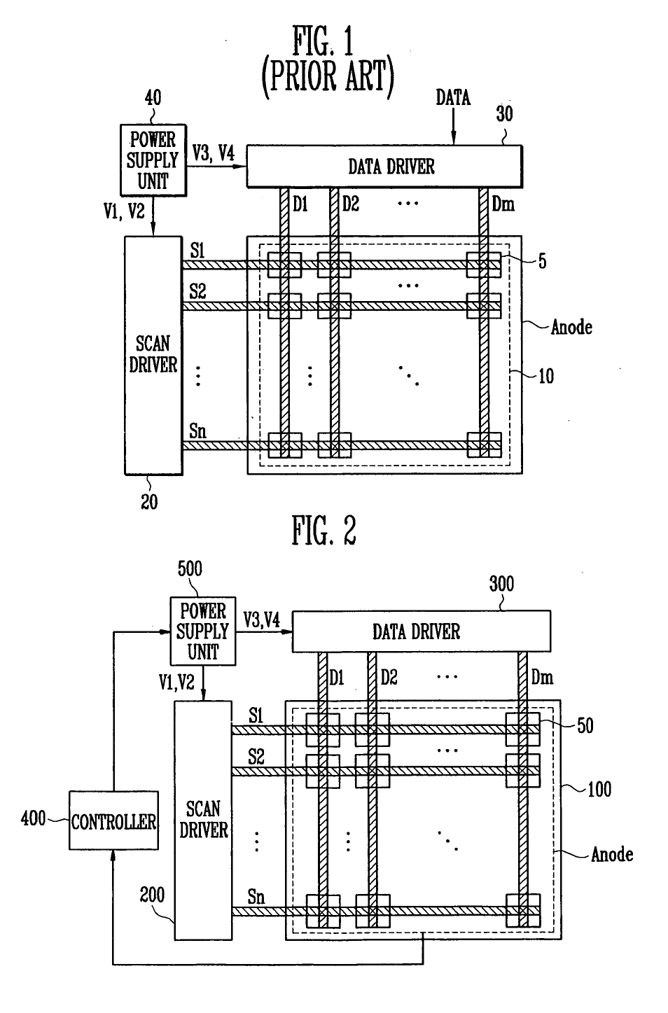

FIG. 2 is a schematic view showing a configuration of an electron emission display device according to an embodiment. With reference to FIG. 2, the electron emission display device includes a pixel portion 100, a scan driver 200, a data driver 300, a controller 400, and a power supply unit 500.

The pixel portion 100 includes n scan lines S1, S2, . . . , Sn, data lines D1, D2, . . . , Dm, and an anode electrode. A plurality of pixels 50 are formed at intersection areas between the scan lines S1, S2, . . . , Sn and m data lines D1, D2, . . . , Dm. The anode electrode may be formed over the entire area of the pixel portion 100. One of the scan lines S1, S2, . . . , Sn and the data lines D1, D2, . . . , Dm may act as a cathode electrode while the other may act as a gate electrode.

The scan driver 200 sequentially applies a scan signal to the scan lines S1, S2, . . . , Sn. The data driver 300 applies a data signal corresponding to input video data to the data lines D1, D2, . . . , Dm, respectively.

The controller 400 changes a voltage according to a drive time and/or a size of a total of video data inputted during one frame time period, and adjusts an electric current through an anode electrode constant based on the changed voltage. Hereinafter, a total of video data inputted to a plurality of pixels 50 is referred to as ‘frame data.’ That is, the controller 400 stores life information of the pixels 50 according to the drive time and/or a size of the frame data. The controller 400 outputs a control signal for adjusting a voltage level between a gate electrode and a cathode electrode according to the stored life information, thereby flowing a constant current to the anode electrode.

The power supply unit 500 applies a first power source V1 and a second power source V2 to the scan driver 200. Further, the power supply unit 500 applies a third power source V3 and a fourth power source V4 to the data driver 300. In addition, the power supply unit 500 adjusts either a difference between a voltage applied to the scan driver 200 and a voltage applied to the data driver 300 (i.e., a voltage difference between a cathode electrode and a gate electrode) or a voltage applied to the anode electrode, thereby maintaining an electric current through an anode electrode of the pixel portion 100 constant.

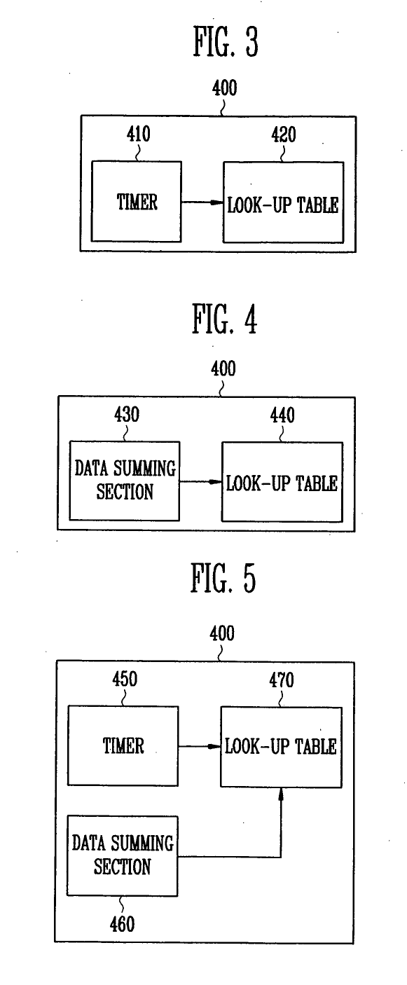

FIG. 3 is a schematic view showing an example of a controller shown in FIG. 2. Referring to FIG. 3, the controller 400 of one embodiment includes a timer 410 and a look-up table 420.

The timer 410 measures and stores the total drive time of the electron emission display device.

The look-up table 420 stores a variable voltage corresponding to the total drive time. First, the life characteristics of pixels (not shown) corresponding to the drive time of the electron emission display device are measured and stored in the look-up table 420. For example, when the pixel portion (FIG. 2) has been used for a predetermined image, an electric current flowing through the anode electrode (FIG. 2) is measured. For example, it is assumed that a voltage corresponding to the measured electric current is 2V when the measured electric current is 2 mA. For example, when 5,000 hours has elapsed since the electron emission device was manufactured, an electric current corresponding to a predetermined image decreases to 1.9 mA. For example, when 10,000 hours has elapsed, an electric current corresponding to a predetermined image decreases to 1.8 mA.

In such a case, the current drop may be compensated as follows. When a voltage for compensating an electric current of 0.1 mA is 0.1 V, after the elapse of 5,000 hours, in place of applying a voltage of 2V, 2.1V (the sum of a compensating voltage of 0.1V and the initial voltage of 2V) is applied. After the elapse of 10,000 hours, 2.2V (the sum of a voltage of 0.2 V and the voltage of 2V) is applied. In such a manner, although the drive time has elapsed, an electric current can be maintained constant as 2 mA for the predetermined image. Accordingly, information on voltage compensation for predetermined times is stored in the look-up table 420. As a result, as time elapses, the voltage is compensated without measuring an electric current, while maintaining the current constant. A skilled artisan will appreciate that various time intervals may be used for the current compensation and that the compensating voltages may vary depending on the design of an electron emission device.

FIG. 4 is a schematic view showing another example of the controller shown in FIG. 2. The controller 400 includes a data summing section 430 and a look-up table 440.

The data summing section 430 sums video data inputted to the pixel portion during a frame time period, and generates frame data. The term “frame date” refers to a sum of video data inputted to a plurality of pixels (not shown) during one frame time period. The greater the size of the frame data is, the greater the emission rate of a pixel portion is, or the more the pixels display a high gradation of image. The data summing section may also include a memory to accumulate the total amount of video data which the pixel portion has received since the start of the use of the electron emission display.

The look-up table 440 stores current compensation information corresponding to a size of the frame data. For example, it is assumed that a data frame value generated by the data summing section 430 is 100, and a corresponding current value is 1 mA, and a voltage corresponding to an electric current of 1 mA is 2V. Here, a voltage for compensating the electric current of 0.1 mA is 0.1V. Each time 0.1V is added, the data frame is compensated by 10. Then, when the electron emission device has been used for a certain period of time, a frame data value generated by the data summing section 430 may decrease to 90 from 100. At this time, if the measured current value is 0.9 mA, an electric current of 0.1 mA and frame data by 10 is compensated. Accordingly, a voltage of 0.1V for compensating an electric current of 0.1 mA and frame data by 10 is added, whereby a voltage of 2.1V is applied. The aforementioned information is stored in the look-up table 440.

Upon driving the electron emission display device, a voltage level is changed according to the information stored in the look-up table 440. This configuration allows an electric current flowing through the anode to be maintained constant without measuring the electric current. That is, the look-up table 440 stores information indicating, for example, that a voltage of 2.1V obtained by adding 0.1V to a previously applied voltage of 2V is applied when generated frame data is 90, and a voltage of 2.2V obtained by adding 0.2V to a previously applied voltage of 2V is applied when generated frame data is 80. A voltage is changed according to the stored frame data without measuring the electric current, thereby maintaining the current amount constant. A skilled artisan will appreciate that various amounts of the frame data may be used for the current compensation and that the compensating voltages may vary depending on the design of an electron emission device.

In another embodiment, the current compensation may be based on the total amount of the frame data which the pixel portion has received since the electron emission display was manufactured. The current compensation information is stored in the look-up table. When the data summing section 430 indicates that the pixel portion has received a predetermined total amount of the frame data, a current compensation is carried out based on the look-up table.

FIG. 5 is a view showing another example of the controller 400. Referring to FIG. 5, the controller 400 includes a timer 450, a data summing section 460, and a look-up table 470. The timer 450 measures the drive time of the electron emission display device. The data summing section 460 sums video data inputted to a pixel portion (not shown) during one frame time period to generate frame data. The data summing section 460 may also include a memory to accumulate the total amount of frame data which the pixel portion has received since the electron emission display was manufactured.

The look-up table 470 stores variable voltage information corresponding to the drive time and size of the frame data. For example, it is assumed that a data frame value generated by the data summing section 460 when a predetermined image is displayed on a pixel portion is 100, and a corresponding current value is 1 mA, and a voltage corresponding to an electric current of 1 mA is 2V. Here, a voltage for compensating for a electric current drop of 0.1 mA is 0.1V. Each time 0.1V is added, the frame data is compensated by 10. Then, when 5,000 hours has elapsed, a frame data value generated by the data summing section 460 may decrease to 90 from 100. At this time, if the measured current value is 0.9 mA, an electric current of 0.1 mA and frame data by 10 should be compensated. Accordingly, a voltage of 0.1V for compensating an electric current of 0.1 mA and frame data by 10 is added, whereby a voltage of 2.1V is applied.

Furthermore, when 10,000 hours has elapsed, a frame data value generated by the data summing section 460 may further decrease to 80. At this time, if the measured current value is 0.8 mA, an electric current of 0.2 mA and frame data by 20 is compensated. Accordingly, a voltage of 0.2V for compensating an electric current of 0.2 mA and frame data by 20 is added, whereby a voltage of 2.2V is applied. The aforementioned information is stored in the look-up table 470.

When driving the electron emission display device, a voltage level is changed according to the information stored in the look-up table 470. This configuration allows an electric current flowing through the anode to be maintained constant without measuring the electric current. The look-up table 470 sets and stores information indicating, for example, that frame data is compensated by 20 by applying a voltage of 2.1 V obtained by adding 0.1V to a previously applied voltage of 2V when 5,000 hours has elapsed, and applying a voltage of 2.2V obtained by adding 0.2V to a previously applied voltage of 2V when 10,000 hours has elapsed after the electron emission display device is driven. A voltage is changed according to the drive time and frame data without measuring the electric current that allows current amount to be maintained constant.

In certain embodiments, the current compensation may be based on the total amount of the time and the total amount of the frame data since the start of the use of the electron emission display. The look-up table 470 includes information on current compensation for total amounts of time and frame data. For example, if the total amount of the frame data has not exceeded a predetermined amount after the elapse of 10,000 hours, the look-up table provides a first compensating voltage value which is smaller than the first value. If, however, the total amount of the frame data has exceeded the predetermined amount after the elapse of 10,000 hours, the look-up table provides a second compensating voltage value which is greater than the first value.

During the operation of the electron emission display device, when the timer indicates that a certain amount of time has elapsed since the start of the use of the display, the controller checks with the data summing section to obtain information about the total amount of the frame data. Using this information, the controller provides a compensating voltage value, referring to the look-up table described above. A skilled artisan will appreciate that various time intervals and frame data amounts may be used for the current compensation and that the compensating voltages may vary depending on the design of an electron emission display device.

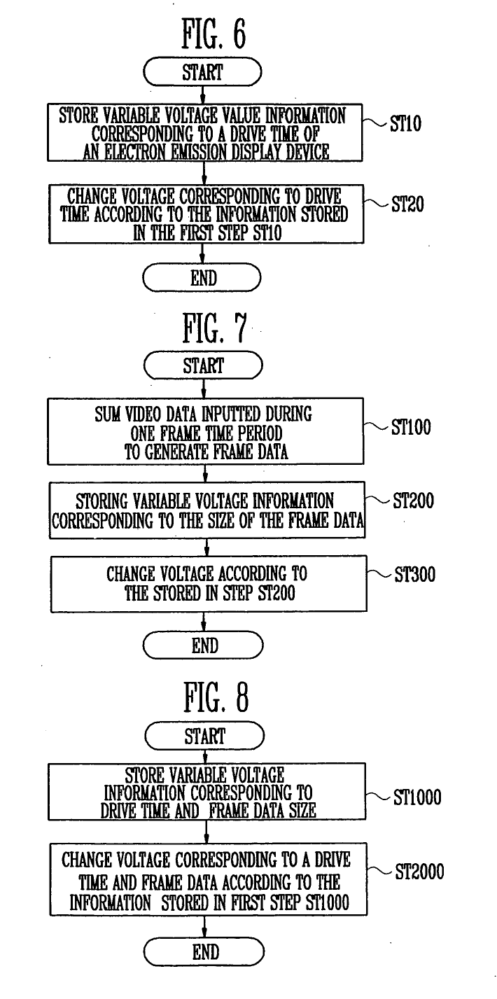

FIG. 6 is a flowchart illustrating a control method of an electron emission display device according to an embodiment.

A first step ST10 is a step of storing information with respect to a variable voltage value as the drive time of an electron emission display device elapses.

First, a timer measures the drive time of the electron emission display device. In addition, the life characteristics of pixels according to the drive time are detected and stored in a look-up table. For example, when a pixel portion has displayed a predetermined image for a predetermined time, an electric current flowing through an anode electrode (not shown) is measured. For example, it is assumed that a corresponding voltage value is 2V when the measured electric current is 2 mA. Further, when 5,000 hours has elapsed, an electric current corresponding to the predetermined image decreases to 1.9 mA. When 10,000 hours has elapsed, the electric current corresponding to the predetermined image decreases to 1.8 mA. Here, if a voltage for compensating an electric current drop of 0.1 mA is set as 0.1V, a voltage of 2.1V obtained by adding 0.1V to a previously applied voltage of 2V is applied after the elapse of 5,000 hours. In addition, a voltage of 2.2V obtained by adding 0.2V to the previously applied voltage of 2V after the elapse of 10,000 hours. In the aforementioned manner, although the drive time elapses, the electric current may be maintained constant as 2 mA for displaying the predetermined image. As a result, information indicating that a voltage obtained by adding 0.1V to a previously applied voltage of 2V is applied after the elapse of 5,000 hours, and that a voltage obtained by adding 0.2V to a previously applied voltage of 2V is applied after the elapse of 10000 hours, is stored in the look-up table.

A second step ST20 is a step of changing a voltage corresponding to a drive time according to the information stored in the first step ST10. Namely, a voltage of 2.1 V obtained by adding 0.1V to a previously applied voltage of 2V is applied after elapse of 5,000 hours, whereas a voltage of 2.2 V obtained by adding 0.2V to a previously applied voltage of 2V is applied after elapse of 10,000 hours. Accordingly, without measuring an electric current, a voltage is changed as time elapses to maintain the current amount constant.

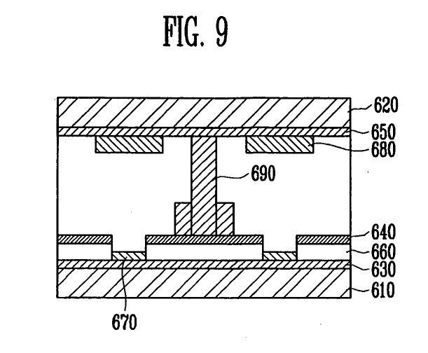

FIG. 7 is a flowchart illustrating a control method of an electron emission display device according to another embodiment. With reference to FIG. 7, the control method of an electron emission display device according to another embodiment is performed through first to third steps ST100 to ST300.

A first step ST100 is a step of summing video data inputted during one frame time period to generate frame data. If a size of the frame data is great, an emission rate of a pixel portion is greater or there are many pixels displaying a high gradation of image.

A second step ST200 is a step of storing variable voltage information corresponding to the size of the frame data. For example, it is assumed that a data frame value generated when a predetermined image is displayed on a pixel portion is 100, and a corresponding current value is 1 mA, and a voltage corresponding to an electric current of 1 mA when a predetermined image is displayed on a pixel portion. Here, a voltage for compensating an electric current drop of 1 mA is 0.1V. Each time 0.1V is added, the data frame is compensated by 10. Then, when a predetermined image is displayed during a next frame time period, a frame data value generated by the data summing section 460 decreases to 90. At this time, if the measured current value is 0.9 mA, an electric current of 0.1 mA and frame data by 10 may be compensated. Accordingly, in the second step ST200, information indicating that a voltage of 0.1V for compensating an electric current of 0.1 mA and frame data by 10 is added to apply a voltage of 2.1V, is stored.

A third step ST300 is a step of changing a voltage according to the stored in step ST200. When the electron emission display device is driven, a voltage level is changed according to information stored in a look-up table. This configuration allows an electric current flowing through an anode electrode to be adjusted constant without measuring the electric current. That is, when frame data generated according to the information stored in the second step ST200 is 90, a voltage of 2.1 V obtained by adding 0.1V to a previously applied voltage of 2V is applied. In contrast to this, when the generated frame data is 80, a voltage of 2.2 V obtained by adding 0.2V to a previously applied voltage of 2V is applied. Consequently, a voltage is changed according to the frame data without measuring the electric current that allows the current amount to be maintained constant.

FIG. 8 is a view illustrating a control method of an electron emission display device according to another embodiment. With reference to FIG. 8, the control method of an electron emission display device is carried out through first and second steps ST1000 and ST2000.

A first step ST1000 is a step of storing variable voltage information corresponding to the drive time and size of frame data. First, video data inputted to a pixel portion during one frame time period are summed to generate frame data. If a size of the frame data is great, an emission rate of a pixel portion is greater or there are many pixels capable of displaying a high gradation of an image. For example, it is assumed that a data frame value generated when a predetermined image is displayed on a pixel portion is 100, and a corresponding current value is 1 mA, and a voltage corresponding to an electric current of 1 mA is 2V. Here, a voltage for compensating the electric current of 0.1 mA is 0.1 V. Each time 0.1V is added, the data frame is compensated by 10. Then, when 5,000 hours has elapsed, the generated frame data value decreases to 90. At this time, if the measured current value is 0.9 mA, an electric current of 0.1 mA and frame data by 10 is compensated. Accordingly, a voltage of 0.1V for compensating an electric current of 0.1 mA and frame data by 10 is added, whereby a voltage of 2.1V is applied. Furthermore, when 10,000 hours has elapsed, the generated frame data value decreases to 80. At this time, if the measured current value is 0.8 mA, an electric current of 0.2 mA and frame data by 20 is compensated. Accordingly, information indicating that a voltage of 2.2 V obtained by applying a voltage of 0.2V for compensating an electric current of 0.2 mA and frame data by 20 is added to the voltage of 2.0V is applied, is stored.

A second step ST2000 is a step of changing a voltage corresponding to drive time and frame data according to the information stored in the first step ST1000. For example, when 5,000 hours elapses after the electron emission display device is driven, a voltage of 2.1 V obtained by adding a voltage of 0.1V to a voltage of 2.0 V is applied to compensate frame data by 10. In addition, when 10,000 hours elapses after the electron emission display device is driven, a voltage of 2.2 V obtained by adding a voltage of 0.2V to a voltage of 2.0 V is applied to compensate frame data by 20. Consequently, the voltage is changed according to the drive time and frame data without measuring an electric current while keeping the emission current amount constant.

FIG. 9 is a view showing an example of an electron emission device used for an electron emission display device according to one embodiment.

With reference to FIG. 9, the electron emission device 600 used for an electron emission display device includes a rear substrate 610, a front substrate 620, a cathode electrode 630, a gate electrode 640, and an anode electrode 650.

The cathode electrode 630 is formed on a surface of the rear substrate 610 in a line pattern. The gate electrode 640 is formed in a line pattern to intersect with the cathode electrode 630 with an insulation layer 660 interposed therebetween.

The anode electrode 650 is formed on a surface of the front substrate 620 in a line pattern in the same direction as that of the cathode electrode 630.

A plurality of grooves are formed in a pixel region at intersections between the cathode electrode 630 and the gate electrode 640. The gate electrode 640 and the insulation layer 660 pierce the grooves. A surface type electron emission portion 670 is formed on the cathode electrode 630 in the groove, and is made of carbon system materials such as carbon nano tube (CNT). The anode electrode 650 is formed at a location opposite to the electron emission portion 670. A fluorescent film 680 is formed on a surface of the anode electrode 650. When electrons emitted from the electron emission portion 670 collide with the fluorescent film 680, the fluorescent film 680 emits light. A spacer 690 supports the rear and front substrates 610 and 620 sealed in high vacuum. One end of the spacer 690 is supported by an anode electrode 650 between the fluorescent films 680, and the other end thereof is supported by the gate electrode 640.

According to the electron emission display device and a control method thereof of the embodiment, variable voltage information according to a drive time and/or a size of frame data is previously stored, a predetermined current flows at the drive time of a real screen, to prevent a degradation of a pixel, with the result that a life of the electron emission display device can be enhanced.

Although a few embodiments have been shown and described, it would be appreciated by those skilled in the art that changes might be made in this embodiment without departing from the principles and spirit of the invention, the scope of which is defined in the claims and their equivalents.

What is claimed is:

1. An electron emission display device comprising:
an array of pixels comprising a first pixel configured to flow an emission current therein and emit light when a pixel voltage is applied thereto; and
a luminance adjusting circuit configured to adjust the pixel voltage based on the extent of use of the device since an initiation of the circuit.

2. The device of claim 1, wherein the luminance adjusting circuit is configured to increase the pixel voltage, thereby increasing the emission current.

3. The device of claim 1, wherein the luminance adjusting circuit is configured to increase the pixel voltage by a predetermined value corresponding to the extent of use of the device.

4. The device of claim 1, wherein the extent of use of the device comprises an accumulated time in which the first pixel is turned on.

5. The device of claim 4, wherein the luminance adjusting circuit is configured to increase the pixel voltage by a predetermined value when the accumulated time reaches a predetermined value.

6. The device of claim 1, wherein the extent of use of the device comprises an accumulated time in which the device is turned on.

7. The device of claim 6, wherein the luminance adjusting circuit comprises a timer for measuring the accumulated time.

8. The device of claim 1, wherein the array is configured to receive data indicative of luminance levels of the pixels when displaying an image, and wherein the extent of use of the device comprises the sum of the luminance levels for at least part of the pixels in the array since the initiation of the circuit.

9. The device of claim 8, wherein the luminance adjusting circuit is further configured to sum the luminance levels.

10. The device of claim 8, wherein the luminance adjusting circuit is configured to increase the pixel voltage by a predetermined value when the sum of luminance levels reaches a predetermined value.

11. The device of claim 8, wherein the extent of use of the device further comprises an accumulated time in which the device is turned on since the initiation of the circuit.

12. The device of claim 11, wherein the luminance adjusting circuit is configured to determine whether the accumulated time reaches a predetermined value when the sum of luminance levels reaches a predetermined value.

13. The device of claim 11, wherein the luminance adjusting circuit is configured to determine whether the sum of luminance levels reaches a predetermined value when the accumulated time reaches a predetermined value.

14. The device of claim 1, wherein the array is configured to receive data indicative of luminance levels of the pixels when displaying an image, and wherein the extent of use of the device comprises an accumulated value of the data received for at least part of the pixels in the array since the initiation of the circuit.

15. The device of claim 14, wherein the luminance adjusting circuit is further configured to sum values of the data.

16. A method of adjusting luminance of an electron emission display device, the method comprising:
providing the device of claim 1;
determining that the extent of use of the device since the initiation of use of the device has reached a predetermined value; and
adjusting the luminance of the first pixel upon determination.

17. The method of claim 16, wherein adjusting the luminance comprises increasing the pixel voltage, thereby increasing the emission current.

18. The method of claim 16, wherein determining comprises:
quantifying the extent of use to a value; and
comparing the quantified value against the predetermined value.

19. The method of claim 18, wherein the luminance adjusting circuit determines that the extent of use has reached the predetermined value when the quantified value is the same or greater than the predetermined amount at the time of determination.

20. The method of claim 18, wherein the device comprises a memory storing a lookup table with a plurality of extent of use values and a plurality of pixel voltage values corresponding to the plurality of extent of use values.
